(19) United States
(12) Patent Application Publication
(10) Pub. No.: US 2022/0112089 A1
(43) Pub. Date: Apr. 14, 2022

(54) Producing Burnt End Products from Natural, Carbonate-Containing, Granular Materials as Starting Raw Materials

(71) Applicant: Litherm Technologies GmbH, Krefeld (DE)

(72) Inventors: Felix Nelles, Krefeld (DE); Thomas Stumpf, Bad Harzburg (DE)

(21) Appl. No.: 17/556,856

(22) Filed: Dec. 20, 2021

Related U.S. Application Data
(63) Continuation-in-part of application No. PCT/EP2020/067186, filed on Jun. 19, 2020.

(30) Foreign Application Priority Data
Jun. 21, 2019 (DE) 102019209043.5
Jun. 21, 2019 (DE) 102019209044.3
Jun. 19, 2020 (EP) PCT/EP2020/067186

(51) Int. Cl. C01F 11/06; B01J 6/00; B01J 8/24; B01J 8/42; C01B 32/50; B01J 19/24; B01D 53/26; F27B 15/00; F27D 17/00

(52) U.S. Cl. CPC C01F 11/06; B01J 6/004; B01J 8/24; B01J 8/42; C01B 32/50; B01J 19/245; F27M 2003/03; F27B 15/00; F27D 17/004; C01P 2006/82; B01J 2208/00389; B01J 2208/00265; F27D 2017/006; B01D 53/263

(57) ABSTRACT

A method for producing burnt end products from an educt (starting raw materials) of carbonate-containing materials involves preheating the educt using heat recovered from the reaction. The educt and a fluidizing medium including steam are input into a first reaction zone. Heat is transferred to the first reaction zone using mechanical components so as to heat the first reaction zone to a predetermined temperature range for a predetermined time period. The educt is burned in the first reaction zone over the predetermined time period during which the first reaction zone is maintained within the predetermined temperature range. The hot gases that form in the first reaction zone include CO₂ and steam. Hot end product is discharged from the first reaction zone after the predetermined time period elapses. Heat contained in the hot gases and end product that are discharged from the first reaction zone is used to preheat the educt.

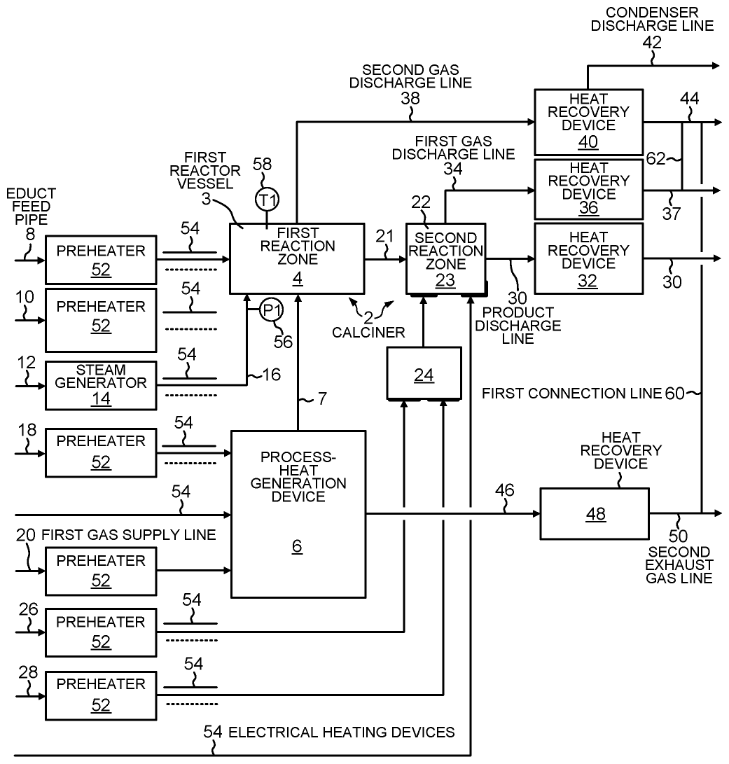

### CROSS REFERENCE TO RELATED APPLICATION

This application is filed under 35 U.S.C. § 111(a) and is based on and hereby claims priority under 35 U.S.C. § 120 and § 365(c) from International Application No. PCT/EP2020/067186, filed on Jun. 19, 2020, and published as WO 2020/254625 A1 on Dec. 24, 2020, which in turn claims priority from German Application No. 102019209043.5, filed in Germany on Jun. 21, 2019 and German Application No. 102019209044.3, filed in Germany on Jun. 21, 2019. This application is a continuation-in-part of International Application No. PCT/EP2020/067186, which is a continuation-in-part of German Application Nos. 102019209043.5 and 102019209044.3. International Application No. PCT/EP2020/067186 is pending as of the filing date of this application, and the United States is an elected state in International Application No. PCT/EP2020/067186. This application claims the benefit under 35 U.S.C. § 119 from German Application Nos. 102019209043.5 and 102019209044.3. The disclosure of each of the foregoing documents is incorporated herein by reference.

### TECHNICAL FIELD

The present disclosure relates to a method for the production of a burnt end product from natural, carbonate-containing, granular materials as educts or starting raw materials.

### BACKGROUND

Carbonate-containing materials, for example limestone or dolomite, change their chemical composition and crystalline structure upon being heated. At temperatures between about 800° C. and 1,200° C., limestone (CaCO₃) is broken down into carbon dioxide (CO₂) and calcium oxide (CaO, quicklime or burnt lime). This process is called lime burning or calcination. In the case of dolomite, the process already begins at about 650° C. For each tonne of pure lime (CaO), about 785 kg of CO₂ are inevitably and irreducibly formed, the CO₂ being released from the mineral CaCO₃. This proportion cannot be reduced, due to the chemical composition of the CaCO₃.

In addition, CO₂ is also created during the process of heat generation through the combustion of carbon-containing fuels. Thereby about 420 kg of CO₂ are produced and emitted per tonne of lime, dependent on the fuel, kiln type and kiln efficiency. In total about 1.2 tonnes of CO₂ are thus produced and emitted per created tonne of lime.

In principle, in the case of conventional lime kilns the lime is burned with the help of hot combustion gases. By admixing air additionally to the stoichiometric air requirement of the combustion, the temperature of the combustion gases is set to the level necessary for the required lime quality. The exhaust gases from lime kilns include mainly nitrogen, carbon dioxide from the combustion, carbon dioxide from the calcination, oxygen, steam and dust. The production of 6.6 million tonnes of lime and dolomite per year (Germany 2011) thus leads to around 7.9 million tonnes of CO₂ emissions per year. It would make sense to separate the released carbon dioxide at the place of origin and to avoid forming the CO₂ from the combustion process as much as possible. Separating carbon dioxide from this gas-dust-mixture for the purposes of carbon capture utilization (CCU) or carbon capture storage (CCS) is, according to the state of the art, extremely costly and uneconomical.

Quicklime is used in a wide range of applications, in industrial processes, in the manufacture of building materials and in environmental applications. The applications place different demands on the quicklime, depending on the intended use. The limits on the use of quicklime are being narrowed further and further by increasingly precise process controls. However, these precise requirements apply to a product whose properties, due to its natural origin, are always subject to certain variation ranges which are shaped by the history of the origin of its original material of limestone. Goal-driven production of quicklime with regard to its requirements despite the natural variation of the starting material thereby requires a precise knowledge of the parameters that influence the resulting quicklime properties from the starting material.

Quicklime is produced by thermal dissociation of limestone (so-called calcination) with the release of carbon dioxide:

CaCO₃+178.4 kJ→CaO+CO₂ (1)

If the quicklime produced is exposed after completion of the calcination to a further temperature influence, sintering processes begin to take effect, which can in part significantly change the physical properties of the product, such as for example specific surface area, bulk density, etc. The extent of these changes can differ significantly depending on the limestone. These sintering processes have a direct influence on quicklime reactivity as one of the most important required parameters for the process control of applications in which quicklime is used. Quicklime reactivity is a product parameter which relates to the conversion rate of the quicklime with water. The enthalpy of the reaction

CaO+H₂O→Ca(OH)₂+65.19 kJ (2)

is thus constant with ΔHR=−65.19 kJ/mol CaO, but the speed with which the reaction takes place and thus the speed of heat release varies depending on the physical and chemical properties of the quicklime. The method for determining the reactivity consists of measuring the time t60 during which the temperature of a lime-water mixture rises from 20° C. to 60° C. under standard conditions. Depending on the reaction speed, which is directly dependent on the sintering of the lime, the limes are divided into hard-, medium- and soft-burnt lime. However, there is no exact definition for delimiting the groups. As reference values, a reaction time of a maximum of two minutes can be assumed for soft-burnt lime, while a reaction time between two and eight minutes characterizes medium-burnt lime, and hard-burnt lime requires an even longer period of time until the full CaO content has been converted into Ca(OH)₂.

For the burning of lime, limestones with a grain size larger than 25 mm are usually used in shaft kilns. Limestones with a grain size sometimes larger than 10 mm are used in special parallel flow-counter flow regenerative kilns (PFR). Typically these grain sizes correspond to only 40-55% of a limestone deposit. Depending on the process, limestone larger than 2 mm can usually be used in rotary kilns with the considerable disadvantage of a significantly higher fuel requirement and thus also with a correspondingly higher CO₂ emission.

The limestone content obtained from the deposits having grain sizes smaller than 20 mm are used to a large extent as unburnt product, e.g., in flue gas desulphurization plants or, as long as the material is not otherwise usable, it is for example returned to the opencast mine. Due to the increasing share of renewable energies in the German electricity mix, the coal phase-out and the implementation of climate protection goals, it is to be assumed that sales in fine limestone for flue gas desulphurization plants will accordingly cease in the foreseeable future. Responsible dealings with valuable natural limestone deposits must also provide for the economical burning of these small grains in the future.

Measures for energy efficiency in the lime burning process have been in development since the beginning of lime burning. In particular, the sophisticated interconnection of hot and cold material flows in PFR kilns (parallel flow-counter flow regenerative kilns) leads to specific energy consumptions that, with technical advances, come closer and closer to the thermodynamic minimum. Due to the high degree of heat recovery in PFR kilns for example, lowering the combustion gas temperature plays a subordinate role. It is the same with throughput; an increase in throughput does not significantly lower the specific energy consumption due to the high degree of heat recovery. In this way it can also be explained why the advantages of calcination with the support of steam, which was disclosed as early as in 1917 in “Das Kalkbrennen im Schachtofen mit Mischfeuerung”, Berthold Block, Springer-Verlag (1917), has not acquired any significant production-related relevance.

PFR (parallel flow-counter flow regenerative) kilns as they are known from DE3038927C2 and DE102016103937A1 work cyclically and are used mostly for burning carbonate-containing raw material, in particular limestone, dolomite or magnesite. The burning of the kiln feed (material to be burned) always takes place in only one of the shafts, while the other shaft works as a regenerative shaft in which the kiln feed/raw material there is preheated for the subsequent burning cycle in that shaft by means of the exhaust gas supplied via the crossover channel from the shaft currently being fired. The burning of the kiln feed in the fired shaft takes place in parallel flow, in that the kiln feed, which is conveyed from top to bottom through the fired shaft due to gravity, has flowing through it combustion gas generated by burners located at the upper end of the shafts. On the other hand, the flow of the kiln feed in the non-burning or regeneratively operated shaft takes place in counter flow, wherein the exhaust gas supplied via the crossover channel, often arranged between the vertical middle and the lower third of the shafts, is discharged at the upper end of the regeneratively operated shaft. Conventional PFR kilns are advantageous for the production of quicklime with high reactivity (so-called soft-burnt lime) because of the relatively long dwell time of the kiln feed in the burning zone in combination with the relatively low firing temperatures of usually between 800° C. and 1000° C. However, these are not well suited for the production of quicklime with low reactivity, so-called hard-burnt lime, and also for the sintering required for the production of hard-burnt lime, for which firing temperatures well above 1000° C. (for example approximately 1700° C.) are required. Here, due to the relatively long dwell time in the firing zone that is typical of PFR kilns, the kiln feed sinters into lumps which, among other things, can lead to a blocked kiln. In addition, in conventional PFR kilns, in the initial section of the cooling zone of the combustion-operated shaft, the cooling zone being located below the crossover duct, there is partial recarbonization of the kiln feed as a result of the relatively intense through-flow by the flue gas coming from the combustion zone, which in this area of the combustion-operated shaft is diverted in the direction of the crossover duct. Around 3645 MJ/t are required to burn one tonne of lime in a balanced PFR kiln. Natural gas is usually used as fuel. Alternatively, lignite dust can be used, but with disadvantageously higher CO₂ emissions. In addition to the fuel requirement, there is also an electricity requirement of approximately 80 MJ/t of quicklime to operate the kiln. (Source: http://www.probas.umweltbundesamt.de/php/prozessdetails.php?id=%7B86C6457F-ABF7-4F8C-803E-794F6EBCB973%7D (Feb. 3, 2016))

When using a fluidized bed or fluid bed process, in order to be able to compete in terms of energy with established processes such as PFR kilns, processes and devices are required as well as a convincing technical and ecologically sustainable concept, which increase the energetic effectiveness to such an extent that the specific energy consumptions are competitive with those of PFR kilns.

Methods for performing endothermic processes with granular educt in a fluidized bed are generally known from DE1767628A, DE69029037T2 and DE2641292C2. EP0501542B1 discloses a method for roasting refractory gold ores by means of a fluidized bed. A disadvantage of these known processes is that combustion products come into contact with the educts and products due to the supply of heat by means of direct combustion in the fluidized bed.

It is therefore the object of the invention to provide a method for the production of a burnt end product, such as lime and cement, with as little impurities as possible from natural, carbonate-containing, granular substances as an educt or starting raw material. It is also an object to provide a device for carrying out this method.

### SUMMARY

A novel method allows the production of a burnt end product, such as lime and cement, from natural, carbonate-containing, granular materials as starting raw materials. A novel apparatus carries out the method. Lime can be burned highly energy-efficiently by combining a steam-assisted fluidization for calcinating carbonate-containing substances with a steam generator unit integrated into the heat recovery process. Water in the fluidizing medium reduces the CO₂ partial pressure in a first reaction zone; consequently calcination already starts at lower temperatures. This in turn has the advantage that less energy has to be expended for the calcination because the starting materials or products need only to be heated to a lower reaction temperature. This reduces the energy supply and increases the efficiency of the process. The higher the proportion of steam in the fluidizing medium, the lower the CO₂ partial pressure and the quicker the thermal dissociation takes place. If CO₂ were used as the fluidizing medium, there would be no need for a complex gas separation. However, the effort required for the heat recovery would be considerable. If the CO₂ that forms during the calcination is separated from the steam-CO₂ mixture as a product and if the process is heated and operated purely electrically, for example with green electricity, there are no CO₂ emissions created as a result of the calcination method.

A method for producing burnt end products from an educt (starting raw materials) of natural, carbonate-containing, granular materials involves preheating the educt and/or a fluidizing medium using heat recovered from the reaction. The educt and the fluidizing medium are input into a first reaction zone that forms a fluidized bed. The fluidizing medium includes steam. Heat is indirectly transferred to the first reaction zone using mechanical components so as to heat the first reaction zone to a predetermined temperature range for a predetermined time period. The educt is burned in the first reaction zone during the predetermined time period during which the first reaction zone is maintained within the predetermined temperature range. The hot gases that form in the first reaction zone are discharged from the first reaction zone. The hot gases include CO₂ and steam. A hot end product is discharged from the first reaction zone after the predetermined time period has elapsed. Heat is recovered from matter that is discharged from the first reaction zone. The heat that is contained in the matter discharged from the first reaction zone, such as the hot gases and/or hot end product, is used to preheat the educt and/or the fluidizing medium. Heat is recovered from the hot gases by condensing the steam included in the hot gases.

An apparatus for producing burnt end products from an educt of natural, carbonate-containing, granular materials includes a heat recovery device that preheats the educt and a fluidizing medium using recovered heat absorbed by the heat recovery device from hot gases and hot burnt end products produced in the reaction. The apparatus includes a first reactor vessel that includes a fluidized bed in which the educt is burned. An educt feed pipe is connected to the first reactor vessel; the educt enters the first reactor vessel through the educt feed pipe. A steam pipe connected to the first reactor vessel. A fluidizing medium that includes steam enters the first reactor vessel through the steam pipe.

The apparatus includes a process-heat generator that generates process heat, which is used to obtain the burnt end products and hot gases from the educt. The hot gases include CO₂ and steam. Mechanical components are disposed at least partly in the first reactor vessel and are used to indirectly transfer the process heat to the first reactor vessel so as to heat the first reactor vessel to a predetermined temperature range for a predetermined time period. The mechanical components include heat pipes that transfer the process heat from the process-heat generator to the first reactor vessel. The burnt end products are discharged from the apparatus through a product discharge line. The hot gases and hot burnt end products flow through the heat recovery device. The educt and fluidizing medium are preheated using recovered heat absorbed by the heat recovery device from the hot gases and the hot burnt end products. The apparatus also includes a second reactor vessel in which the burnt end products that are received from the first reactor vessel are sintered. The burnt end products are discharged from the second reactor vessel through the product discharge line.

Other embodiments and advantages are described in the detailed description below. This summary does not purport to define the invention. The invention is defined by the claims.

### BRIEF DESCRIPTION OF THE DRAWINGS

The accompanying drawing illustrates embodiments of the invention.

The FIGURE is a schematic presentation of an exemplary embodiment of the invention.

### DETAILED DESCRIPTION

Reference will now be made in detail to some embodiments of the invention, an example of which is illustrated in the accompanying drawing.

By combining steam-assisted fluidization for the calcination of substances containing carbonate with a steam generator unit that is integrated into the heat recovery process, lime can be burned in a highly energy-efficient manner. Water in the fluidizing medium reduces the CO₂ partial pressure in a first reaction zone 4, as illustrated in the FIGURE. Consequently, calcination already starts at lower temperatures. This in turn has the advantage that less energy has to be expended for the calcination because the educts (starting raw materials, reagents, reactants) or products need to be heated to a lower reaction temperature. This reduces the energy supply and increases the efficiency of the process. The higher the proportion of steam in the fluidizing medium, the lower the CO₂ partial pressure and the quicker the thermal dissociation takes place. If CO₂ were used as the fluidizing medium, there would be no need for a complex gas separation. However, the effort required for the heat recovery would be considerable. The indirect heat transfer or heating of the reaction zone through mechanical components in the reaction zone prevents direct contact between fuel, exhaust gas and the product (solid or gaseous) so that the product is not contaminated. This is different with conventional lime burning processes because in that case, on the one hand the exhaust gases flow through the product and thus come into contact with the product, and on the other hand the burning of hard-burnt lime has very strict requirements for the fuel specification. The advantage of the present invention is that the desired lime qualities can be produced with a variety of fuels. Furthermore, with the invention there is no contact between exhaust gas or fuel and the educt or product, so that the fuel can also contain sewage sludge, for example.

By using steam as a fluidizing medium, hot steam-containing product streams and exhaust gas streams can transfer their heat to the process water cycle and can be used for heating or steam generation. By using the fluidizing medium generated in this way, the energy obtained through heat recovery goes back into the reaction zone. A decisive criterion for the economic success is the thermal efficiency of the process. Parallel flow-counter flow reactor processes or shaft kiln processes are thermally highly efficient processes that are close to the theoretical maximum efficiency due to the design or process control. The efficiency of the fluidized bed process must be supported by heat recovery in order to improve efficiency.

The condensation of the steam contained in the hot gas from the first reaction zone 4 constitutes an efficient and simple process for CO₂ separation and heat recovery. The matter discharged from the first reaction zone 4 can be just steam or a mixture of one or more of steam, CO₂ and air. In one embodiment, steam and CO₂ from the limestone leave the first reaction zone 4 as a mixture. If just air is used as the fluidizing medium, a very large process-engineering effort is required to separate CO₂ from the air. On the other hand, steam can be simply separated by condensation. At the same time, the condensation is a highly efficient method to recover heat from the process. With this process, the objective of obtaining concentrated CO₂ also becomes greatly technologically simplified and economically attractive. The highly concentrated CO₂ can be used as product. If other gases such as air or flue gases were used for fluidization, the CO₂ would have to be separated in a costly, i.e., energy-intensive, way such as by means of pressure swing adsorption, chemical or physical washes, etc. In the preferred embodiment, this CO₂ concentrating is dispensed with.

The condensed hot water obtained during the condensation is used again to generate steam as the fluidizing medium for the fluidization. On the one hand, fresh water does not need to be heated to the condensate temperature. On the other hand, the fresh water requirement of the process is reduced, which has a positive effect on the ecological balance and cost effectiveness.

The method allows for advantageous temperature ranges to be used in the reaction zones. Even solid, gaseous, or liquid fuels and/or electricity can be used to generate process heat.

The control energy in the public power grid is also called operating reserve and serves as a reserve to balance out fluctuations in the power grid, more precisely the power grid frequency. When using control energy, electricity can not only be removed from the electricity grid, but also additionally fed into the electricity grid. More power feed-in to compensate for a network frequency that is too low is referred to as positive control energy, and throttling of the feed-in to reduce the network frequency is called negative control energy. Participants in the control energy market must keep the agreed control energy available. The availability for use and, in the case that the control energy is taken-up, also the actual use, is remunerated. Industrial processes that are able to meet the criteria for participating in the control energy market have an economic advantage. Due to the use of electricity for the process heat generation and the possibility of using fuels additionally or exclusively for the process heat generation, the disclosed process is suitable for participating in the balancing energy market.

The indirect heat transfer by means of heat pipes prevents contact between fuel, exhaust gas and the product (solid or gaseous) so that the product does not become contaminated. The heat transfer from heat pipes is higher than with flue gas heat exchangers and thus enables compact reactor dimensions and in this regard lower investment costs.

By separating calcination and sintering, an exact setting of the conditions for calcining and for sintering is possible. While PFR kilns have process-related difficulties to produce hard-burnt lime, this is possible with the novel method. While the process conditions in the first reaction zone 4 of the first reactor vessel 3 are tailored to fast thermal dissociation, the process conditions in the second reaction zone 23 of the second reactor vessel 22 (the sintering chamber) are aimed at refining the product to a medium or hard-burnt lime, i.e., t60 value. This means that for the first reactor vessel 3, the heat input into the educt or starting raw material must be high, and the carbon dioxide partial pressure must be low. In the sintering chamber, the product must first be heated to the sintering temperature and, depending on the requirements for the t60 value, remain at this temperature for a correspondingly long time. A fluidization is not absolutely necessary for this. Preheating, calcination and heat recovery do not necessarily have to take place in three separate reactors; they can take place sequentially within the first reactor vessel 3 in corresponding successive reaction zones.

In one embodiment, the hot end products and hot gases that form in the second reaction zone 23 are discharged, and the heat contained therein is used for preheating the reactants, which include the educt and the fluidizing medium. In the conventional production of lime or dolomite, only one type of kiln is usually used per product class (soft-, medium- or hard-burnt). With the novel method, all product classes can be produced with one aggregate according to customer requirements, and time for product changeovers (types), due to the short cycle times of a few minutes to hours, is less than for conventional kilns (greater than ten hours). Therefore, with the novel method, product changes are possible within a few hours.

When starting up/heating up and shutting down/cooling down the educt or the product, condensation occurs when using steam as the fluidizing medium. Condensate and already burned material react to form the undesired product hydrated lime. To start up and shut down the process, it can be advantageous to use CO₂ and/or air instead of steam as the fluidizing medium.

By using agglomerated educts, cement and hydraulic lime can be produced with the novel method. Agglomeration is a collective term for the process of increasing grain size by the joining of grains. Agglomeration is above all used with fine-grained or powdered educts in order to improve the pourability and thus the workability. Very fine-grained powders often have an extremely low bulk density, can be easily stirred up, tend to adhere to surfaces, etc. Powder particles combined by agglomeration are considerably easier to handle and process. The novel method makes use of the fact that by mixing chemically different starting materials, the chemical composition of the respective agglomerates can be set very precisely. Due to the pre-defined mixture and the contact surfaces and contact points between the individual mixture constituents brought about or forced by the agglomeration, mineral formation is enabled without the mixture having to be melted (be molten liquid) as is the case with cement production in rotary kilns.

The novel method avoids the energy-intensive (high CO₂ emissions) melting of the mixture by enabling energy-efficient mineral formation when using raw materials. Even where the agglomerated raw material of the educt is partly melted, the proportion of the melted agglomerated raw material in the educt in the first reaction zone 4 and the second reaction zone 23 is less than 20% by weight.

Agglomeration is carried out preferably by pelletizing or briquetting. The novel method advantageously uses an educt with a water content of up to 20% by weight for the agglomerated raw material in order to minimize the disintegration of the agglomerated raw material at temperatures greater than 100° C. due to water-evaporation related flaking.

Due to the forced mixing and contact surfaces or contact points within an agglomerate, the melting of the agglomerate for mineral formation when using agglomerated raw materials is not absolutely necessary but is in principle not avoidable at temperatures close to the melting point of the individual raw materials. It is therefore advantageous to keep the proportion of the melted agglomerated raw materials below 20% by weight of the educt in order to avoid clumping of several fused agglomerates, but in particular for reasons of energy efficiency.

Because the first reactor vessel 3 with the first reaction zone 4 and the process-heat generation device 6 are spatially and materially separated from one another, the process parameters during the combustion can always be set to optimize combustion. This is not the case with conventional firing processes, especially with hard-burnt lime. The nitrogen oxides (NOx) and volatile hydrocarbons that form during usual combustion processes in the burning process are also reduced by the separate combustion. The nitrogen oxides (NOx) and volatile hydrocarbons that form during usual combustion processes in the burning process are even avoided entirely when electricity is used to generate process heat. If electricity is used as a substitute for fuel, no exhaust gas is emitted at the plant for this amount of energy. If the electricity is based on renewable energy, the CO₂ footprint falls accordingly, i.e., the proportion of substituted fuel drops to zero.

There are several advantages of steam fluidization in which the fluidizing medium consists only of steam.

First, the lowering of the carbon dioxide partial pressure in the calcining reactor leads to faster calcinating with simultaneous lowering of the calcining temperature. This reduces the energy expenditure, while at the same time increasing throughput.

Second, high degrees of calcination can be achieved.

Third, steam as a fluidizing medium can be fed back into the process through condensation.

Fourth, the separation of the fluidizing medium and CO₂ from the calcinating by condensation is efficient and easy technically to implement. This enables very high levels of purity for CO₂, which then in turn can be used as product. So the novel method allows this CO₂-intensive process to be CO₂ neutral.

The exemplary embodiment according to the FIGURE includes a calciner 2 having a first reactor vessel 3 for the production of quicklime from limestone. A first reaction zone 4 in the form of a fluidized bed is formed in the first reactor vessel 3. The heat required for heating the reaction zone 4 and for calcination is provided by a process-heat generation device 6. The heat from the process-heat generation device 6 is coupled into the first reactor vessel 3 by means of mechanical components 7. Fine-grain limestone is supplied, via an educt feed pipe 8, to the first reactor vessel 3 having the first reaction zone 4 in the form of a fluidized bed. CO₂ and/or air for starting up or shutting down is supplied, via a fluidizing medium supply line 10, as a fluidizing medium to form the fluidized bed 4. Water or steam is supplied to a steam generator 14 via a supply line 12. The steam generated in the steam generator 14 is supplied to the first reactor vessel 3 with the fluidized bed 4 via a steam pipe 16. Fuel for generating the necessary process heat for the first reactor vessel 3 is supplied to the process-heat generation device 6 via a first fuel supply line 18. Air, O₂, and/or CO₂ are supplied to the process-heat generation device 6 via a first gas supply line 20.

The first reactor vessel 3 is connected via an intermediate product line 21 to a second reactor vessel 22 in the form of a sintering chamber with a second reaction zone 23. In the sintering chamber 22, the educt calcined in the first reactor vessel 3 is subjected to a sintering process. The heat required for this is provided by a combustion chamber 24, to which is supplied O₂-containing gas via a second gas line 26 and fuel via a second fuel supply line 28. The hot end product is drawn off from the sintering chamber 22 via a product discharge line 30 and cooled in a first heat recovery device 32. The cooled end product is discharged via product discharge line 30. Hot gases from the sintering chamber 22 are discharged from the sintering chamber 22 via a first gas discharge line 34 and pass through a second heat recovery device 36. The cooled exhaust gases are emitted to the atmosphere via a first exhaust gas line 37. Hot gases from the first reactor vessel 3 are drawn off via a second gas discharge line 38 and cooled in a third heat recovery device 40 in the form of a condenser, whereby CO₂ gas is separated. Condensate that forms is discharged from the condenser 40 via a condenser discharge line 42. The separated CO₂ is discharged from the condenser 40 via a CO₂ discharge line 44. Exhaust gases from the process-heat generation device 6 are supplied via a third gas discharge line 46 to a fourth heat recovery device 48 and cooled. The cooled exhaust gases are discharged via a second exhaust gas line 50.

The heat recovered in the heat recovery devices 32, 36, 40, 48 is used to preheat the educts, the fluidizing medium, the fuels and the O₂-containing gases. To this end, the educt feed pipe 8, the fluidizing medium supply line 10, the supply line for water/steam 12, the fuel supply lines 18, 28, the gas supply lines 20, 26, each pass through the preheater 52 or the steam generator 14 into which the recovered heat in the heat recovery devices 32, 36, 40, 48 is coupled (in order not to overload the drawing, this is not shown in the drawing). Electrical heating devices 54 are connected downstream of the preheaters 52 and the steam generator 14 in order to be able to additionally heat educts, fluidizing medium, steam, fuel, and gases containing O₂. The process-heat generation device 6 and the sintering chamber 22 can also be heated directly via electrical heating devices 54. In the fluidizing medium supply line 10 or the steam pipe 16, a first pressure measuring device 56 is arranged directly in front of the first reactor vessel 3. The temperature in the first reaction zone 4 of the first reactor vessel 3 is monitored via a first temperature measuring device 58.

First the granular limestone in the fluidized bed 4 of the first reactor vessel 3 is heated to at least the temperature at which the calcination begins. The heat required for this is supplied directly or indirectly into the fluidized bed 4 from the process-heat generation device 6 by means of the mechanical components 7. The product quicklime is gradually formed out of limestone through this heat supply. The CO₂ that forms during the calcination, powdered quicklime, other residues, and the fluidizing gas are discharged from the first reactor vessel 3 via the second gas discharge line 38. The product quicklime (CaO) is transferred, via the intermediate product line 21 either in the form of a crossover or an outlet, from the first reactor vessel into the sintering chamber 22.

In the process-heat generation device 6, as long as carbon-containing fuel and O₂ as the oxidizing agent optionally diluted with CO₂ is used, then the exhaust gas from the process-heat generation device 6 consists predominantly of CO₂. In this case the exhaust gas, consisting essentially of CO₂, in the second exhaust gas line 50 can be reused together with the CO₂ gas in the CO₂ discharge line 44 as a CO₂ product. This is indicated by a first connection line 60 between the second exhaust gas line 50 and the CO₂ discharge line 44. The CO₂ in the third gas line 46 can also be used as part of the fluidizing medium for the fluidized bed 4 (not shown).

As long as the exhaust gas from the combustion chamber 24 is highly concentrated CO₂, it can also be supplied as a product to the CO₂ product flow 44 via a second connection line 62.

The operating mode of the fluidized-bed calciner 2 can in principle be carried out in batch operation, continuously, or in semi-batch operation. Preheating, calcination and heat recovery do not necessarily have to be performed in three separate reactors; they can also be located one after the other within a single reactor as corresponding zones.

By changing the dwell time and/or the temperature in the calciner 2, the end product can be influenced in a targeted manner and thus soft-, medium- or hard-burnt lime can be generated. The temperature in the calciner 2 can be increased by the addition of O₂ in the combustion chamber of the process-heat generation device 6 or by electrical heating of the fluidizing gas in the fluidized bed 4 and thus also allow the generation of medium-burnt and hard-burnt lime.

Depending on the chemical composition of the educts and the desired target quality (t60 value or degree of sintering), it might be necessary for dwell times that are higher and/or longer than can be made possible in the first reaction zone 4. The dwell times and temperatures in the sintering chamber 22 or the second reaction zone 23 are set in accordance with these requirements.

With the device according to the FIGURE, cement and hydraulic lime can also be produced when one uses as educts (in the form of pellets or briquettes, for example) agglomerated raw materials that contain silicon dioxide (SiO₂), aluminum oxide, iron compounds (especially Fe₂O₃ such as from iron ore or iron compounds from calcinated pyrites, contaminated ore, iron oxide/fly ash mixture, steel mill dust, mill scale), as well as calcium carbonate and/or calcium oxide.

### REFERENCE NUMERALS

2 calciner
3 first reactor vessel
4 first reaction zone, fluidized bed
6 process-heat generation device
7 mechanical components for transferring heat
8 educt feed pipe
10 fluidizing medium supply line
12 supply line for water/steam
14 steam generator
16 steam pipe
18 first fuel supply line
20 first gas supply line
21 intermediate product line
22 second reactor vessel, sintering chamber
23 second reaction zone
24 combustion chamber
26 second gas supply line
28 second fuel supply line
30 product discharge line
32 first heat recovery device
34 first gas discharge line
36 second heat recovery device
37 first exhaust gas line
38 second gas discharge line
40 third heat recovery device, condenser
42 condenser discharge line
44 CO₂ discharge line
46 third gas discharge line
48 fourth heat recovery device
50 second exhaust gas line
52 preheater
54 electrical heating devices
56 first pressure measuring device
58 first temperature measuring device
60 first connection line between 50 and 44
62 second connection line between 37 and 44

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1-23. (canceled)

24. A method for producing burnt end products from an educt of natural, carbonate-containing, granular materials, comprising:
a) inputting the educt and a fluidizing medium into a first reaction zone that forms a fluidized bed, wherein the fluidizing medium includes steam;
b) indirectly transferring heat to the first reaction zone using mechanical components so as to heat the first reaction zone to a predetermined temperature range for a predetermined time period, wherein the educt is burned in the first reaction zone during the predetermined time period during which the first reaction zone is maintained within the predetermined temperature range;
c) discharging from the first reaction zone hot gases that form in the first reaction zone, wherein the hot gases include CO₂ and steam;
d) discharging an end product from the first reaction zone after the predetermined time period has elapsed, wherein the end product is hot; and
e) recovering heat contained in matter that is discharged from the first reaction zone.

25. The method of claim 24, wherein the recovered heat is used to preheat the educt.

26. The method of claim 24, wherein the recovered heat is used to preheat the fluidizing medium.

27. The method of claim 24, wherein the fluidizing medium consists of steam.

28. The method of claim 24, wherein heat is recovered from the hot gases by condensing the steam included in the hot gases, and wherein CO₂ is separated from the steam by condensing the steam.

29. The method of claim 24, wherein the steam included in the fluidizing medium is condensed to obtain water, and wherein the water obtained by condensing the steam is reused to generate the steam that is included in the fluidizing medium.

30. The method of claim 24, wherein the heat contained in both the hot gases and the end product discharged from the first reaction zone is used to preheat the fluidizing medium.

31. The method of claim 24, wherein the educt is burned in the first reaction zone during the predetermined time period during which the first reaction zone is maintained within the predetermined temperature range so as to produce a burnt end product of hard-burnt lime but not medium-burnt lime.

32. The method of claim 24, wherein the predetermined temperature range is 380° C. to 1200° C.

33. The method of claim 24, wherein the heating of the first reaction zone is performed by using electrical energy.

34. The method of claim 24, wherein the heating of the first reaction zone is performed by combustion of fuels.

35. The method of claim 24, wherein the mechanical components used for indirectly transferring heat to the first reaction zone include heat pipes.

36. The method of claim 24, further comprising:
f) receiving the end product that is discharged from the first reaction zone into a second reaction zone; and
g) heating the second reaction zone to a second predetermined temperature range, wherein the second predetermined temperature range is 400° C. to 1600° C.

37. The method of claim 36, wherein the heating of the second reaction zone is performed by using electrical energy.

38. The method of claim 36, wherein the heating of the second reaction zone is performed by combustion of fuels.

39. The method of claim 36, wherein heat pipes are used for indirectly transferring heat to the second reaction zone.

40. The method of claim 24, wherein the educt is burned in the first reaction zone during the predetermined time period so as to produce a first burnt end product of hard-burnt lime, and wherein the educt is burned in the first reaction zone during a second predetermined time period so as to produce a second burnt end product of medium-burnt lime.

41. The method of claim 24, wherein while the first reaction zone is being heated to the predetermined temperature range, the fluidizing medium includes CO₂ and air.

42. The method of claim 24, wherein the educt includes agglomerated raw materials selected from the group consisting of: silicon dioxide (SiO₂), aluminum oxide, iron(III) oxide, calcium carbonate and calcium oxide.

43. The method of claim 42, wherein the agglomerated raw materials of the educt are partly melted, and wherein the melted agglomerated raw materials form a proportion of less than 20% by weight of the educt in the first reaction zone.

44. The method of claim 24, wherein the educt is pelleted or briquetted.

45. The method of claim 24, wherein the educt has a water content by weight of 20% or less.

46. An apparatus for producing burnt end products from an educt of natural, carbonate-containing, granular materials, comprising:
a first reactor vessel that includes a fluidized bed in which the educt is burned;
an educt feed pipe connected to the first reactor vessel, wherein the educt enters the first reactor vessel through the educt feed pipe;
a steam pipe connected to the first reactor vessel, wherein a fluidizing medium enters the first reactor vessel through the steam pipe, and wherein the fluidizing medium includes steam;
a process-heat generator that generates process heat, wherein the process heat is used to obtain the burnt end products and hot gases from the educt, and wherein the hot gases include CO₂ and steam;
mechanical components disposed at least partly in the first reactor vessel, wherein the mechanical components are used to indirectly transfer the process heat to the first reactor vessel so as to heat the first reactor vessel to a predetermined temperature range for a predetermined time period;
a product discharge line through which the burnt end products are discharged from the apparatus; and
a heat recovery device through which the hot gases and hot burnt end products flow.

47. The apparatus of claim 46, wherein the fluidizing medium is preheated using recovered heat absorbed by the heat recovery device from the hot gases and the hot burnt end products.

48. The apparatus of claim 46, wherein the educt is preheated using recovered heat absorbed by the heat recovery device from the hot gases and the hot burnt end products.

49. The apparatus of claim 46, wherein the recovered heat absorbed by the heat recovery device from the hot gases and the hot burnt end products is used to preheat the educt.

50. The apparatus of claim 46, wherein the process-heat generator is a combustion device that receives a fuel through a fuel supply line and an oxidizing agent through a gas supply line, and wherein the fuel and the oxidizing agent are preheated by the heat recovery device.

51. The apparatus of claim 46, further comprising:
a second reactor vessel in which the burnt end products received from the first reactor vessel are sintered, wherein the burnt end products are discharged from the second reactor vessel through the product discharge line.

52. The apparatus of claim 51, wherein the first reactor vessel and the second reactor vessel are integrally formed as a single vessel.

53. The apparatus of claim 46, wherein the mechanical components include heat pipes that transfer the process heat from the process-heat generator to the first reactor vessel.

54. The apparatus of claim 46, wherein the heat recovery device includes a condenser that condenses the steam included in the hot gases and thereby separates the CO₂ from the steam.
